(19) United States
(12) Patent Application Publication
(10) Pub. No.: US 2013/0131384 A1
(43) Pub. Date: May 23, 2013

(54) PROCESS FOR RESTORING CATALYST ACTIVITY

(71) Applicants: Michael Merkel, Dusseldorf (DE); Thomas Knauf, Dormagen (DE); Karl-Heinz Wilke, Moers (DE)

(72) Inventors: Michael Merkel, Dusseldorf (DE); Thomas Knauf, Dormagen (DE); Karl-Heinz Wilke, Moers (DE)

(21) Appl. No.: 13/812,873

(22) PCT Filed: Jul. 26, 2011
(86) PCT No.: PCT/EP2011/062832

§ 371 Date: Jan. 29, 2013

(30) Foreign Application Priority Data
Jul. 30, 2010 (DE) 10 2010 038 680.4

(51) Int. Cl. B01J 38/48

(52) U.S. Cl. CPC B01J 38/48
USPC 564/420; 502/22

(57) ABSTRACT

The present invention relates to a process for restoring the activity of spent catalysts for the hydrogenation of aromatic nitro compounds, in which a regeneration comprising at least a first burning off stage, a first washing stage, a second burning off stage and a second washing stage is carried out at periodic intervals.

The present invention relates to a process for restoring the activity of spent catalysts for the hydrogenation of aromatic nitro compounds, in which a regeneration comprising at least a first burning off stage, a first washing stage, a second burning off stage and a second washing stage is carried out at periodic intervals.

A reactivation process for noble metal catalysts supported on α-aluminium oxide is described in U.S. Pat. No. 3,684,740 (equivalent to DE OS 20 28 202). The basis of this purification process for catalysts is that the catalyst activity and the catalyst selectivity can be restored by a regeneration comprising the burning off of carbon- containing deposits and a subsequent washing once with water. This publication discloses that during continuous operation of a catalytic hydrogenation unit the activity and selectivity of the catalyst decrease ever further because of the deposition of polymer species and other possible poisons on the catalyst. This makes a periodic regeneration necessary. The standard regeneration according to the prior art at the time of filing of U.S. Pat. No. 3,684,740 usually comprised only the burning off of carbon- containing material by allowing an inert gas which contains small amounts of oxygen to act on the catalyst at elevated temperatures. After some regenerations comprising only a burning off step, however, a catalyst can lose any hydrogenating activity. U.S. Pat. No. 3,684,740 thus teaches that washing of the catalyst with water carried out after the burning off stage can return the catalyst activity and selectivity to a significantly higher level, indeed even virtually to initial levels, over additional periods of time. In this context, washing of the catalyst is carried out continuously by passing water through a fixed catalyst bed. According to U.S. Pat. No. 3,684,740, considerable savings in catalyst costs and downtimes of the reactor thereby result.

In the event of only one burning off of carbon-containing deposits and subsequent washing with water, however, in practice the original catalyst activity often cannot be restored in the case of spent catalyst supported on aluminium oxide and containing palladium, vanadium and lead, such as is used for hydrogenation of nitroaromatics (see, for example, EP 0 944 578 A2, EP 0 011 090 A1, EP 0 696 574 B1, EP 0 696 573 B1, EP 1 882 681 A1). Contamination of the catalyst which occurs e.g. due to salt-containing nitroaromatics (see EP 1 816117 B1 for details of these problems), corrosion of parts of the installation or contaminated hydrogen and which cannot be removed by the processes of the prior art is the explanation for this. If a catalyst purified according to the prior art is treated with air again at temperatures of from 270° C. to 280° C., burning off of further carbon-containing material is observed, which indicates the incompleteness of the purification procedure. This leads to ever poorer operating times of installations for the hydrogenation of nitroaromatics and therefore to the necessity of having to replace the spent catalyst by fresh catalyst, which is very expensive.

An object of the present invention was therefore to provide a process for restoring the activity of catalysts employed in the hydrogenation of nitroaromatics to give aromatic amines which makes it possible to be able to employ the catalyst again and again over long periods of time, so that purchase of fresh catalyst is reduced to a minimum.

The object is achieved by a process for restoring the activity of a catalyst employed in the hydrogenation of nitroaromatics by regeneration at periodic intervals, wherein the regeneration of the catalyst comprises at least the following stages:
(i) a first burning off stage comprising a treatment of the catalyst with regenerating gas containing oxygen in the range of from 0.1 vol. % to 90 vol. %, preferably from 5 vol. % to 50 vol. %, particularly preferably from 15 vol. % to 25 vol. %, based on the total volume of the regenerating gas;
(ii) a first washing stage comprising a discontinuous treatment of the catalyst from (i) with water with mechanical mixing, in the volume ratio of catalyst:water in the range of from 1:1 to 1:100, preferably in the range of from 1:2 to 1:75, particularly preferably in the range of from 1:4 to 1:50, very particularly preferably in the range of from 1:5 to 1:25;
(iii) a second burning off stage comprising a treatment of the catalyst with regenerating gas containing oxygen in the range of from 0.1 vol. % to 90 vol. %, preferably from 5 vol. % to 50 vol. %, particularly preferably from 15 vol. % to 25 vol. %, based on the total volume of the regenerating gas;
(iv) a second washing stage comprising a discontinuous treatment of the catalyst from (iii) with water with mechanical mixing, in the volume ratio of catalyst:water in the range of from 1:1 to 1:100, preferably in the range of from 1:2 to 1:75, particularly preferably in the range of from 1:4 to 1:50, very particularly preferably in the range of from 1:5 to 1:25.

These at least four purification stages can optionally be followed by further burning off and washing stages like (i) and (iii) respectively and (ii) and (iv) respectively. In this context, the last purification stage can be either a washing or a burning off stage.

Preferred aromatic amines in the preparation of which the catalyst regenerated according to the invention is employed are compounds of the formula

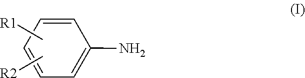

in which R1 and R2 independently of each other denote hydrogen, methyl or ethyl, wherein R1 can additionally denote NH₂. These are obtained by hydrogenation, preferably gas phase hydrogenation, of nitroaromatics of the formula

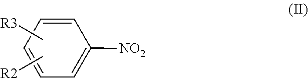

in which R2 and R3 independently of each other denote hydrogen, methyl or ethyl, wherein R3 can additionally denote NO₂. Particularly preferred aromatic amines are aniline (R1=R2=H) and toluylenediamine (R1=NH₂; R2=methyl), prepared from nitrobenzene (R2=R3=H) and, respectively, dinitrotoluene (R2=methyl; R3 =NO₂). A very particularly preferred aromatic amine is aniline. The invention accordingly in particular also relates to the use of a catalyst, the activity of which is restored at periodic intervals by the regeneration according to the invention comprising at least stages (i) to (iv), in the hydrogenation of nitrobenzene or dinitrotoluene to give the corresponding amines.

The hydrogenation of the nitro compounds is preferably carried out continuously and with recycling of unreacted hydrogen into the reaction. Preferably, the catalyst is arranged in the form of fixed catalyst beds. Reaction procedures as described in EP 0 944 578 A2 (isothermal procedure) and in EP 0 696 574 B1, EP 0 696 573 B1, EP 1 882 681 A1 (adiabatic procedure) are particularly preferred. The procedure described in EP 1,882,681 A1 is very particularly preferred.

In the course of an operating cycle the catalyst increasingly loses activity as a consequence of coking deposits and deposition of salts (e.g. originating from impurities in the nitroaromatic). In the context of this invention, “activity of the catalyst” is understood as meaning the ability of the catalyst to react the nitroaromatics employed for as long as possible and as completely as possible. In this context, the activity can be quantified in various ways; this is preferably done via the duration of an operating cycle, which is also called “service life”. Service life is understood as meaning the period of time between the start of the hydrogenation and the occurrence of significant amounts of unreacted nitroaromatics in the crude reaction product which necessitates ending of the reaction. In this context, “significant amounts” are weight contents of nitroaromatics of greater than 1,000 ppm, preferably greater than 500 ppm, particularly preferably greater than 100 ppm, based on the total weight of the organic content of the crude reaction product.

When such a significant content of nitroaromatic is reached in the reaction product, the hydrogenation is interrupted and the catalyst is regenerated. Depending on how long the service life reached is compared with the service life which can be achieved with a fresh catalyst of the same catalyst system (“ideal service life”), various methods are used to regenerate the catalyst, i.e. to restore its activity as completely as possible. A catalyst system here is understood as meaning a certain type of catalyst, that is to say, for example, the catalyst type described in EP 0 011 090 A1 consisting of Pd (9 g per litre of support), V (9 g per litre of support) and lead (3 g per litre of support) on α-aluminium oxide.

If the service life achieved is only slightly below the ideal service life, in general a single burning off stage for removal of carbon-containing deposits is sufficient to restore the activity of the catalyst to an adequate extent. However, if the service life achieved is significantly shorter than the ideal service life, the regeneration process according to the invention comprising at least stages (i) to (iv) is preferably carried out. Preferably, the regeneration according to the invention comprising at least stages (i) to (iv) is always carried out if the activity of the catalyst employed in the hydrogenation falls below 30%, preferably below 50%, particularly preferably below 80% of the activity of a fresh catalyst of the same catalyst system, the activity preferably being quantified via the ratio of service life achieved to ideal service life. The regeneration process according to the invention is thus preferably carried out at “periodic intervals” which are defined via the loss of activity found for the catalyst.

Burning off stages (i) and (iii) and optionally further burning off stages of the process according to the invention are preferably carried out at temperatures of between 200° C. and 500° C., preferably between 240° C. and 400° C., particularly preferably between 260° C. and 350° C., very particularly preferably between 270° C. and 300° C., air preferably being employed as the regenerating gas containing oxygen. At the start of a burning off stage, the air is in general also diluted with nitrogen, in order to avoid too high an increase in temperature. At least burning off stage (i) is preferably carried out in the reactor for the hydrogenation.

Washing stages (ii) and (iv) and optionally further washing stages are carried out discontinuously with mechanical mixing, i.e. the catalyst to be purified is covered with water in the abovementioned volume ratio in a suitable apparatus and the suspension obtained is mixed mechanically. In the case of the catalyst, the catalyst volume entering into the calculation of the volume ratio is the bulk volume. The mechanical mixing in washing stages (ii) and (iv) and optionally in further washing stages
is preferably carried out by stirring, the stirring energy being adjusted such that 99.0% by weight to 100% by weight, preferably 99.5% by weight to 100% by weight, particularly preferably 99.9% by weight to 100% by weight of the catalyst, based on the total weight of the catalyst to be washed in the particular stage, remains structurally intact;
and
is preferably carried out for periods of time of between 2 minutes and 60 minutes, particularly preferably for periods of time of between 10 minutes and 30 minutes.

A particularly intensive contact between the catalyst to be purified and the wash water is established by this means, which makes possible a more effective purification than with the continuous washing process from U.S. Pat. No. 3,684,740. In this context, “structurally intact” means that the particles of which the catalyst consists (e.g. spheres or other shaped bodies) do not break up in the washing procedure. At most superficial abrasion may occur.

In addition to stirring, other methods of mechanical mixing are also possible, for example by controlled generation of flows, e.g. by introduction of gases, such as, for example, nitrogen or air, or by pumping the wash medium in circulation. Suitable apparatuses for carrying out washing stages (ii) and (iv) and optionally further washing stages are, for example, washtubs or concrete mixers. If suitable devices for the mechanical mixing are present in the reactor, the reactor itself can also be a suitable washing device. In that case removal and re-introduction of the catalyst out of and into the reactor are superfluous.

Preferably, the water in washing stages (ii) and (iv) and optionally further washing stages has a temperature of between 4° C. and 100° C., particularly preferably between 10° C. and 70° C. and very preferably between 15° C. and 50° C. The water employed for the washing must be largely to completely free from ions which impair the catalyst activity (e.g. sulfate). The best results are therefore achieved with distilled water. It is particularly economical for the aromatic amines to be prepared by gas phase hydrogenation of the corresponding nitroaromatics, for the reaction product obtained in each case in this way, which contains gaseous, crude amine and water of reaction, to be condensed and separated into an organic and an aqueous phase by phase separation, and for the water for washing stage (ii) and/or washing stage (iv) and/or further washing stages to originate from the aqueous phase obtained in this way. In this embodiment, the water for washing stage (ii) and/or washing stage (iv) thus originates from the aqueous phase which was obtained by phase separation of the condensed crude reaction product of a gas phase hydrogenation of nitroaromatics. Before carrying out washing stages (ii) and (iv) and optionally further washing stages, the catalyst treated with regenerating gas is allowed to cool, and in particular preferably to the temperature of the washing water.

For the washing stages following the first washing, the wash liquid from the preceding washing stages can be re-used if it is not loaded too highly with ions which impair the catalyst activity (e.g. sulfate). Working up of this wash water, e.g. by filtration or sedimentation and decanting, can optionally be carried out in between. Preferably, the last washing stage is carried out with fresh wash water, particularly preferably with water from the aqueous phase obtained as described above in the phase separation.

When the discontinuous treatments of the catalyst with water have ended, the wash water is removed, preferably by filtration. Thereafter, the catalyst is preferably freed from residues of impurities adhering to the surface by rinsing off with running water.

The damp catalyst is preferably dried before the following burning off stage or before renewed use in the hydrogenation. Preferably, the drying is carried out in a stream of warm air, optionally under reduced pressure, preferably in the range of from 50 mbar to 1,000 mbar.

The spent catalyst is preferably sieved at least once during the regeneration comprising at least stages (i) to (iv), in order to separate off dust particles. Preferably, this is effected between the burning off stages and the washing stages. Particularly preferably, the catalyst to be regenerated is sieved before stage (ii) and/or before stage (iv) and/or before further washing stages to remove dust particles with an average particle diameter of <1 mm. The sieving of the catalyst is carried out by means of apparatuses and methods known to the person skilled in the art.

Cyclones, sieves etc. e.g. are employed. By this additional purification step, the load in the waste water can be reduced and disposal simplified in this way.

The regeneration process according to the invention is particularly suitable for purification of the hydrogenation catalysts described in EP 0 944 578 A2, EP 0 011 090 A1, EP 0 696 574 B1, EP 0 696 573 B1 and EP 1 882 681 A1. In particular, it is suitable for restoring the activity of a catalyst for the hydrogenation of aromatic nitro compounds, in which the catalyst contains catalytically active components on an aluminium oxide support with an average diameter of the aluminium oxide particles of between 1.0 mm and 7.0 mm and a BET surface area of less than 20 m²/g, and in which the active components comprise at least:
(a) 1-100 g/lₛᵤₚₚₒᵣₜ of at least one metal of groups 8 to 12 of the periodic table of the elements, and
(b) 0-100 g/lₛᵤₚₚₒᵣₜ of at least one transition metal of groups 4 to 6 and 12 of the periodic table of the elements, and
(c) 0-100 _{g/l}ₛᵤₚₚₒᵣₜ of at least one metal of the main group elements of groups 14 and 15 of the periodic table of the elements.

(In this publication, the groups of the periodic table of the elements are numbered according to the IUPAC recommendation of 1986.)

The aluminium oxide support preferably has an approximately spherical shape and preferably a diameter in the range of from 1.0 mm to 7.0 mm.

The breaking hardness of spent catalyst, washed and dried 20 times, of the catalyst type Pd (9 g/lₛᵤₚₚₒᵣₜ)/V (9 g/lₛᵤₚₚₒᵣₜ)/Pb (3 g/lₛᵤₚₚₒᵣₜ) on α-aluminium oxide remains unchanged, that is to say the mechanical stability of the catalyst is not impaired by washing several times.

### EXAMPLES

A 500 mm long reaction tube of stainless steel which is charged with educts via a vaporizer serves as the experimental installation for the reaction examples. Nitrobenzene is pumped into the vaporizer from the top by means of metering pumps. The hydrogen is passed from the bottom into the vaporizer, which is heated (approx. 250 ° C.) by thermostatically controlled oil baths, so that the nitrobenzene pumped in from the top can vaporize in counter-current. The hydrogen supply is regulated by a mass flow regulator upstream of the vaporizer. In all the experiment examples the load was set at 1 g_{nitroaromatic}/(ml_{catalyst}·h) and the hydrogen:nitrobenzene ratio at approx. 80:1.

A 400 mm high heap of the catalyst is placed on a sieve within the reaction tube. After exit from the reactor, the reaction product is cooled with water. The non-volatile constituents are condensed out in this way and separated from the gaseous components in a downstream separator. The liquid constituents are led from the separator into the product collecting tank and collected there (glass container). Upstream of the collecting tank is a sampling point, at which samples of the product can be taken at regular intervals of time. These are analysed by gas chromatography. The service life of the catalyst corresponds to the time from the start of the reaction until complete conversion of the nitrobenzene is no longer achieved and >0.1% of nitrobenzene is detected in the product at the sampling point by means of gas chromatography.

All the examples were carried out with the catalyst system of 9 g/lₛᵤₚₚₒᵣₜ of Pd, 9 g/lₛᵤₚₚₒᵣₜ of V, 3 g/lₛᵤₚₚₒᵣₜ of Pb on α-aluminium oxide (see EP 0 011 090 A1). Catalysts of this catalyst system which had been aged and pretreated in various ways were employed; the reaction experiments were in each case interrupted when the service life of the catalyst was reached.

### Example 1

### Comparison Example

“Fresh Catalyst”

Freshly prepared catalyst was placed in the reaction tube and flushed first with nitrogen and then with hydrogen. Thereafter, the catalyst was charged with 1,000 l/h of hydrogen at 240° C. over a period of time of 48 h. The nitrobenzene load was then increased slowly to the desired value of 1 g_{nitroaromatic}/(ml_{catalyst}·h), so that the temperature in the reactor did not rise above 450° C., and the addition of hydrogen was adjusted such that the molar ratio of hydrogen:nitrobenzene was 80:1.

### Example 2

### Comparison Example

### “Regenerated Without Washing”

A spent catalyst with a low residual activity which was used for the hydrogenation of nitrobenzene to give aniline was regenerated by a burning off stage. For this, it was first heated to 270° C. and then charged with a stream of air in order to burn off coking deposits. This was carried out until no further release of heat was to be detected and the CO₂ content in the waste gas stream had fallen to less than 0.2% (determined by IR photometry). Thereafter, the system was rendered inert with nitrogen and the catalyst was charged with 1,000 l/h of hydrogen at 240° C. over a period of time of 48 h. The nitrobenzene load was then increased slowly to the desired value of 1 g_{nitroaromatic}/(ml_{catalyst}·h), so that the temperature in the reactor did not rise above 450 ° C., and the addition of hydrogen was adjusted such that the molar ratio of hydrogen:nitrobenzene was 80:1.

### Example 3

### Comparison Example “Reactivated in Accordance with DE-OS-2028 202”

Spent catalyst with a low residual activity from the same batch as in Example 2 was employed, and this time was reactivated in accordance with DE-OS-20 28 202, i.e. it was first heated to 270° C. and then charged with a stream of air in order to burn off coking deposits. This was carried out until no further release of heat was to be detected and the CO₂ content in the waste gas stream had fallen to less than 0.2%. After cooling, the catalyst was washed continuously with distilled water until the stream of wash water flowing out of the catalyst was clear for approx. 20 minutes, and was then dried with hot inert gas.

For rendering the system inert, the catalyst was first flushed with nitrogen. The catalyst was then charged with 1,000 l/h of hydrogen at 240° C. over a period of time of 48 h. The nitrobenzene load was then increased slowly to the desired value of 1 g_{nitroaromatic}/(ml_{catalyst}·h), so that the temperature in the reactor did not rise above 450° C., and the addition of hydrogen was adjusted such that the molar ratio of hydrogen:nitrobenzene was 80:1.

### Example 4

### Comparison Example

### Renewed Burning off after the Washing with Water

A portion of the catalyst sample prepared in Example 3 was not rendered inert and used for the reaction in the conventional manner after the reactivation procedure, but was first heated once more to 270° C. and treated by covering with a flow of air. It was possible here to observe again CO₂ contents of more than 1.5% in the waste air and an increase in temperature of several degrees, which indicates further burning off of carbon-containing material. Air was passed over the catalyst again until the CO₂ content in the waste air fell below 0.2%. Thereafter, the system was rendered inert with nitrogen and the catalyst was charged with 1,000 l/h of hydrogen at 240° C. over a period of time of 48 h. The nitrobenzene load was then increased slowly to the desired value of 1 g_{nitroaromatic}(ml_{catalyst}·h), so that the temperature in the reactor did not rise above 450° C., and the addition of hydrogen was adjusted such that the molar ratio of hydrogen:nitrobenzene was 80:1.

### Example 5

### According to the Invention

### “Multiple Reactivation”

The spent catalyst which also served as the starting material for the treatment in Example 2 was first regenerated in the conventional manner in a stream of air at 270° C. until no further heat was released and the CO₂ content in the waste gas had fallen below 0.2%. The catalyst was then charged with 5 times the volume of water in a mixing apparatus and the mixture was stirred at room temperature for 10 minutes. The catalyst washed in this way was rinsed off with water under a washing spray head and dried at 100° C. This procedure of burning off in a stream of air and washing with water was carried out again a further two times, before the catalyst was rendered inert in the reactor and charged with 1,000 l/h of hydrogen at 240° C. over a period of time of 48 h. The nitrobenzene load was then increased slowly to the desired value of 1 g_{nitroaromatic}(ml_{catalyst}·h), so that the temperature in the reactor did not rise above 450° C., and the addition of hydrogen was adjusted such that the molar ratio of hydrogen:nitrobenzene was 80:1.

### Example 6

### According to the Invention

### “Multiple Reactivation with Sieving”

The spent catalyst which also served as the starting material for the treatment in Example 2 was first regenerated in the conventional manner in a stream of air at 270° C. until no further heat was released and the CO₂ content in the waste gas had fallen below 0.2%. The catalyst was removed from the reactor and fine contents present (abraded material, dust-like impurities) were removed by sieving the catalyst with a sieve of pore size 1 mm. The catalyst was then charged with 5 times the volume of water in a mixing apparatus and the mixture was stirred for 10 minutes. The catalyst washed in this way was rinsed off with water under a washing spray head and dried at 100° C. This procedure of burning off in a stream of air and washing with water was carried out again a further two times, before the catalyst was rendered inert in the reactor and charged with 1,000 l/h of hydrogen at 240° C. over a period of time of 48 h. The nitrobenzene load was then increased slowly to the desired value of 1 g_{nitroaromatic}/(ml_{catalyst}·h), so that the temperature in the reactor did not rise above 450° C., and the addition of hydrogen was adjusted such that the molar ratio of hydrogen:nitrobenzene was 80:1.

The following table summarizes the results:

TABLE 1
Results of the examples

| | | Service | Na content of the | |
|---|---|---|---|---|
| No. | Type | life | catalyst^{[a]} | |
| Example 1 | comparison (fresh cat.) | 987 h | 56 | ppm |
| Example 2 | comparison | 152 h | 0.18% | |
| Example 3 | comparison | 318 h | 0.12% | |
| Example 4 | comparison | 376 h | 0.11% | |
| Example 5 | according to | 826 h | 370 | ppm |
| | the invention | | | |
| Example 6 | according to | 818 h | 355 | ppm |

the invention

^{[a]}Weight contents are stated; determined by ICP-OES

As is seen, the service life achieved with the catalyst regenerated only by burning off (Example 2) is considerably shorter than that achieved with fresh catalyst (Example 1). If the burning off stage is also followed by a washing stage (Example 3), the service life indeed increases again, but only by a third, from 150 h to 200 h. Further burning off then indeed leads once more to a noticeable increase in the service life from 200 h to 300 h (Example 4), but service lives which lie again in the same order of magnitude as the ideal service life are achieved only with the procedure according to the invention.

The sodium content is an important indication of the contamination of the catalyst and is significantly lower in the examples according to the invention than in the comparison examples.

1-11. (canceled)

12. A process for restoring the activity of a catalyst employed in the hydrogenation of nitroaromatics comprising regenerating the catalyst at periodic intervals, wherein regenerating comprises at least the following stages:
(i) a first burning off stage comprising a treatment of the catalyst with regenerating gas containing oxygen in the range of from 0.1 volume % to 90 volume %, based on the total volume of the regenerating gas;
(ii) a first washing stage comprising a discontinuous treatment of the catalyst from (i) with water with mechanical mixing, in the volume ratio of catalyst:water in the range of from 1:1 to 1:100;
(iii) a second burning off stage comprising a treatment of the catalyst from (ii) with regenerating gas containing oxygen in the range of from 0.1 volume % to 90 volume %, based on the total volume of the regenerating gas; and
(iv) a second washing stage comprising a discontinuous treatment of the catalyst from (iii) with water with mechanical mixing, in the volume ratio of catalyst:water in the range of from 1:1 to 1:100.

13. The process according to claim 12, in which the regenerating gas in burning off stages (i) and (iii) contains oxygen in each case in the range of from 5 volume % to 50 volume %, based on the total volume of the regenerating gas, and the volume ratio of catalyst:water in washing stages (ii) and (iv) is in each case in the range of from 1:2 to 1:75.

14. The process according to claim 12, in which the regenerating gas in the burning off stages (i) and (iii) contains oxygen in each case in the range of from 15 volume % to 25 volume %, based on the total volume of the regenerating gas, and the volume ratio of catalyst : water in washing stages (ii) and (iv) is in each case in the range of from 1:5 to 1:25.

15. The process according to claim 12, in which the catalyst contains catalytically active components on an aluminium oxide support with an average diameter of the aluminium oxide particles of between 1.0 mm and 7.0 mm and a BET surface area of less than 20 m²/g, and in which the active components comprise at least:
(a) 1-100 g/lₛᵤₚₚₒᵣₜ of at least one metal of groups 8 to 12 of the periodic table of the elements, and
(b) 0-100 g/lₛᵤₚₚₒᵣₜ of at least one transition metal of groups 4 to 6 and 12 of the periodic table of the elements, and
(c) 0-100 g/lₛᵤₚₚₒᵣₜ of at least one metal of the main group elements of groups 14 and 15 of the periodic table of the elements.

16. The process according to claim 12, in which the catalyst to be regenerated is sieved before stage (ii) and / or before stage (iv) to remove dust particles with an average particle diameter of <1 mm.

17. The process according to claim 12, in which the water in washing stages (ii) and (iv) has a temperature of between 4° C. and 100° C.

18. The process according to claim 12, in which the mechanical mixing in washing stages (ii) and (iv)
is carried out by stirring, the stirring energy being adjusted such that 99.0% by weight to 100% by weight of the catalyst, based on the total weight of the catalyst to be washed in the particular stage, remains structurally intact;
and
is carried out for periods of time of between 2 minutes and 60 minutes.

19. The process according to claim 12, in which burning off stages (i) and (iii) are carried out at temperatures of between 200° C. and 500° C. and air is employed as the regenerating gas containing oxygen.

20. The process according to claim 12, in which regenerating comprising stages (i) to (iv) is always carried out when the activity of the catalyst employed in the hydrogenation falls below 80% of the activity of a fresh catalyst of the same catalyst system.

21. The process according to claim 12, in which the water for washing stage (ii) and/or washing stage (iv) originates from an aqueous phase which was obtained by phase separation of a condensed crude reaction product of a gas phase hydrogenation of nitroaromatics.

22. A process for the hydrogenation of nitrobenzene or dinitrotoluene comprising utilizing a catalyst regenerated according to the process of claim 12.
